(19) United States
(12) Patent Application Publication
(10) Pub. No.: US 2016/0290452 A1
(43) Pub. Date: Oct. 6, 2016

(54) FULL TORQUE CRANK ASSEMBLIES

(71) Applicant: David Joseph Ransil, Encino, CA (US)

(72) Inventor: David Joseph Ransil, Encino, CA (US)

(21) Appl. No.: 14/675,374

(22) Filed: Mar. 31, 2015

(51) Int. Cl. F16H 19/04; F02B 75/32

(52) U.S. Cl. CPC F16H 19/043; F02B 75/32

(57) ABSTRACT

A crank assembly, comprising: a connecting rod; first gear; second gear; geared rotational guide; and crank journal. The connecting rod may have a gear end, which may be substantially oblong in shape. The oblong gear end of the connecting rod may comprise a geared interior surface, which may be configured to matingly engage with the first gear. The geared interior surface may comprise a long side length and a short side length, which is greater than a diameter of the first gear. The crank journal may be within the first gear, which may be configured to be in moveable but continuous contact with the geared interior surface. The first gear is connected to the second gear, such that when the first gear is rotated the second gear is also rotated. The second gear may matingly engage with and rotationally move within the geared interior surface of the geared rotational guide.

### FIELD OF INVENTION

This invention relates generally to crank assemblies, connecting rods, gears, driveshafts, and crankshafts used to convert energy produced in a combustion engine into rotational energy. More specifically, the invention relates to connecting rod and crankshaft combinations that utilize a system of gears to transfer energy while maintaining a relatively constant, high, and essentially full torque.

### BACKGROUND

The modern combustion engine generally utilizes a piston and connecting rod to translate explosive energy into useful rotational energy. The pistons are actuated in a linear manner by explosive force and drive a connecting rod, which causes the crank shaft to rotate as the piston moves linearly. The linear motion is transferred into rotational motion.

Torque, or the turning force that is exerted upon the crank, is directly proportional to the length of the lever arm. Thus, when the piston is at the top or bottom of its movement path, the length of that lever is zero—which generates zero torque. Torque increases to its maximum as the crank rotates to a 90-degree position relative to the plane of the piston's travel, but rises from zero and falls back to zero before and after that point. This zero torque cycle inherently wastes a significant amount of the energy and power generated by combustion, resulting in low efficiency for internal combustion engines. Indeed, a well-tuned engine is at most about 17% efficient, with much of the efficiency losses occurring as a direct result of the conversion of the linear motion of the piston into a circular or rotational motion of the crank.

The majority of losses encountered in current designs stems from the highly unproductive method by which the piston's linear motion is converted to circular motion using conventional connecting rods and cranks. This method was first devised in the year 1206 CE by inventor Al-Jazari, and its inefficiencies have not been challenged since that time.

In order to compensate for the inefficiency of the cranks and connecting rods of the standard piston engine, engines have been designed to have as many peak torque moments as possible. Thus, short-stroke, high-revving motors have been developed to provide for a relatively greater number of peak torque moments per revolution of the vehicle's wheels. Short-stroke, high-revving engines have several disadvantages, as compared to lower revving engines, such as having higher friction and greater inertial forces (encountered at the top and bottom of each stroke) to overcome.

Thus, there is a need for a crank assembly that provides more consistent torque when translating linear energy produced by a combustion engine into rotational energy. Having torque more consistently applied to the system would make the system much more efficient, which would allow the system to be low-revving. This would preferably help reduce inertial forces and lower friction, which would further increase efficiencies.

### SUMMARY

To minimize the limitations in the cited references, and to minimize other limitations that will become apparent upon reading and understanding the present specification, the crank assemblies disclosed use connecting rods and crankshaft gears to more efficiently transfer the linear motion of the piston to the rotational motion of the crank by maintaining a relatively constant, high, and essentially full torque during motion.

One embodiment of the crank assembly, comprises: a connecting rod; a first gear; a second gear; a geared rotational guide; and a crank journal. The connecting rod has a gear end and wherein the gear end of the connecting rod may be substantially oblong in shape. The oblong gear end of the connecting rod comprises a first geared interior surface. The first geared interior surface of the oblong gear end of the connecting rod may be configured to matingly engage with the first gear. The first geared interior surface of the oblong gear end of the connecting rod has a long side length and a short side length. The short side length may be greater than a diameter of the first gear. The crank journal may be rotateably received by the first gear. The first gear is configured to be in moveable but continuous contact with the first geared interior surface of the oblong gear end of the connecting rod. The first gear may be connected to the second gear, such that when the first gear may be rotated the second gear may also be rotated. The second gear may be configured to matingly engage with and rotationally move within a second geared interior surface of the geared rotational guide. The second gear's motion along the second geared interior surface of the geared rotational guide causes the crank journal to move in a substantially circular motion. The geared rotational guide may be substantially circular. The crank journal may be connected to a crankshaft, and wherein the crankshaft may be rotated when the crank journal moves in the substantially circular motion. The connecting rod may have a piston end that may be configured to be connected to and driven by a piston. The piston may linearly drive the connecting rod, which in turn drives the first gear, which moves the second sear within the geared rotational guide. The crank assembly may further comprise: a follower gear; and a follower gear connector. The oblong gear end of the connecting rod may further comprise a geared exterior surface, which may be configured to matingly engage with the follower gear. The follower gear and the crank journal may be connected via the follower gear connector, such that the follower gear and the first gear are on opposite sides of the oblong gear end of the connecting rod, and such that the first gear may be in moveable but continuous contact with the first geared interior surface of the oblong gear end of the connecting rod while the follower gear may be in moveable but continuous contact with the geared exterior surface of the oblong gear end of the connecting rod. The first gear may be freely rotatable around the crank journal.

In another embodiment, the crank assembly may comprise: a connecting rod; a first gear; a second gear; a follower gear; a follower gear connector; a geared rotational guide; and a crank journal; wherein the connecting rod has a piston end that may be configured to be connected to and driven by a piston; wherein the connecting rod has a gear end and wherein the gear end of the connecting rod may be substantially oblong in shape; wherein the oblong gear end of the connecting rod comprises a first geared interior surface and a geared exterior surface; wherein the first geared interior surface of the oblong gear end of the connecting rod may be configured to matingly engage with the first gear; wherein the first geared interior surface of the oblong gear end of the connecting rod has a long side length and a short side length; wherein the short side length may be greater than a diameter of the first gear; wherein the geared exterior surface of the oblong gear end of the connecting rod may be configured to matingly engage with the follower gear; wherein the crank journal may be rotateably received by the first gear, such that the first gear may be freely rotatable around the crank journal; wherein the follower gear and the crank journal are connected via the follower gear connector, such that the follower gear and the first gear are on opposite sides of the oblong gear end of the connecting rod, and such that the first gear may be in moveable but continuous contact with the first geared interior surface of the oblong gear end of the connecting rod while the follower gear may be in moveable but continuous contact with the geared exterior surface of the oblong gear end of the connecting rod; wherein the first gear may be connected to the second gear, such that when the first gear rotates the second gear also rotates; wherein the second gear may be configured to matingly engage with and rotationally move within a second geared interior surface of the geared rotational guide; wherein the geared rotational guide may be substantially circular; wherein the second gear's motion along the second geared interior surface of the geared rotational guide causes the crank journal to move in a substantially circular path; wherein the piston linearly drives the connecting rod, which in turn moves and rotates the first gear, which moves the second gear within the geared rotational guide; and wherein the crank journal may be connected to a crankshaft, and wherein the crankshaft may be rotated when the crank journal moves in a substantially circular motion. There may be a plurality of crank assemblies that are connected to and work together to rotate the crankshaft.

Another embodiment is a crank assembly, comprising: a connecting rod; a first gear; a second gear; a countershaft; a third gear; a fourth gear; and a driveshaft. The connecting rod may have a gear end and wherein the gear end of the connecting rod may be substantially oblong in shape; wherein the oblong gear end of the connecting rod comprises a geared interior surface; wherein the geared interior surface of the oblong gear end of the connecting rod may be configured to matingly engage with the first gear. The geared interior surface of the oblong gear end of the connecting rod may have a long side length and a short side length; wherein the short side length may be greater than a diameter of the first gear. The first gear may be matingly engaged with the second gear, such that when the first gear may be rotated the second gear may be also rotated in an opposite direction. The second gear may be configured to be solidly connected to the third gear; wherein the third gear may be matingly engaged to the fourth gear, such that when the third gear may be rotated the fourth gear may be rotated in an opposite direction; and wherein the fourth gear may be configured to be connected to the driveshaft. The crank assembly may further comprise: a follower gear; and a follower gear connector. The oblong gear end of the connecting rod may further comprise a geared exterior surface; wherein the geared exterior surface of the oblong gear end of the connecting rod may be configured to matingly engage with the follower gear; and wherein the follower gear are connected via the follower gear connector, such that the follower gear and the first gear are on opposite sides of the oblong gear end of the connecting rod, and such that the first gear may be in moveable but continuous contact with the geared interior surface of the oblong gear end of the connecting rod while the follower gear may be in moveable but continuous contact with the geared exterior surface of the oblong gear end of the connecting rod. The connecting rod has a piston end that may be configured to be connected to and driven by a piston. There may be a driveshaft within (rotateably received by) the first gear, such that the first gear may be freely rotatable around the driveshaft (with minimal friction). The second and third gears may be rotateably connected to the countershaft. The third and fourth gears may be substantially elliptical in shape. A piston may linearly drive the connecting rod, wherein movement of the connecting rod causes the first gear to rotate, which causes the second gear to rotate, which causes the third gear to rotate, which causes the fourth gear to rotate, which causes the driveshaft to rotate.

It is an object of the present crank assembly to provide substantially full torque from the piston to the crank assembly and to the driveshaft during the vast majority of the piston stroke.

It is an object of the present crank assembly to provide a more efficient crank assembly.

It is an object of the present crank assembly to achieve maximum efficiency for internal combustion engines by eliminating the losses incurred by conventional connecting rods and cranks. Prior to the present crank assembly, combustion energy currently only applies force on the crank and or driveshaft as the connecting rod positions near a 90-degree angle relative to the crank position. Because of this, short-stroke, high-revving motors are preferred as they offer more “peak moments” of power per revolution of the vehicle wheel. The present crank assembly preferably allows the combustion force to achieve full (or substantially full) torque throughout almost the entire combustion cycle. Thus, the present crank assembly reduces and/or eliminates the need for more engine revolutions per revolution of the wheel. As such, the present crank assembly allows for lower-revving motors, which may result in lower frictional losses. Importantly, each time the piston must stop and reverse direction at the top and bottom of its stroke, inertial forces generally must be overcome. These inertial forces rise with higher revving engines. Thus, with lower revving engines, less inertial forces would need to be overcome.

Accordingly, in addition to the substantial gains in torque of the present crank assembly, the crank assembly may yield even more efficiency gains by obviating the need for high-revving motors, decreasing frictional and inertial losses, as well as the hydraulic “drag” created by pistons moving through oily cylinders. Finally, less friction means engines would wear more slowly and last longer.

An additional objective is to present a greatly more efficient technology to the automotive industry that does not require substantial changes to current manufacturing techniques. In fact, though engines half the size would deliver the same or more power with the present invention, the entire top end of the engine may remain the same. The present crank assembly design addresses only the bottom end—connecting rod and crank—allowing the commercial auto industry to utilize the knowledge and manufacturing techniques perfected over the last 100 years for all other aspects of engine production. Additionally, the present crank assembly does not need to have opposing pistons in V-engines sharing a crank journal, as in the conventional engine layout, combustion events could occur at equal divisions of crank rotation, which in turn would eliminate much of the vibration experienced by conventional engines that fire unevenly due to shared crank journals.

Less vibration of the present crank assembly may reduce or eliminate the need for counterweights on the crank, resulting in less rotating mass overall. Further, because the present crank assembly may use helical gears, instead of spur gears, this would share the load across multiple gear teeth and help the present crank assembly to withstand the shock of combustion. Helical gears also quiet the operation, and assure a smoother, more complete torque delivery.

In conventional engine designs, the piston and connecting rod never develop full torque on the crank even at their peak torque moments. This is because the piston is centered over the crankshaft or driveshaft, which means that the connecting rod is never at a full 90-degree angle to the crank at the point where the most torque is developed. This generally results in vector losses. The present crank assembly utilizes gears that are always turning tangentially to each other, at 90 degrees, which creates maximum torque during the entire combustion cycle (with the exception of when the connecting rod and piston are at the two extremes of their travel). Thus, not only would the present crank assembly deliver full torque throughout nearly the entire combustion cycle, the torque it creates throughout that cycle is superior to the maximum torque created at the single peak moment of the conventional technology.

In a gas-fueled, naturally-aspirated engine, combustion pressure peaks at only 15 degrees of crank rotation. That is generally halfway between 12 o'clock and one o'clock. Present-day connecting rods and cranks generally produce almost zero torque at that point. Pressure declines from there as the piston descends, but torque rises as the piston moves toward the center of the cylinder and the connecting rod/crank angle improves. Using standard connecting rods and cranks, torque is highest at 42 degrees, because this is the best intersection of available pressure and rising mechanical advantage of connecting rods/cranks. But conventional engines have the best torque potential at 72 degrees (which plus 18 degrees of connecting rod angle equals 90 degrees). However, at 72 degrees, combustion pressure has fallen so much, conventional engines produce less torque at 72 degrees than at 42 degrees, even though they produce their best mechanical advantage at 72 degrees. Furthermore, even at 72 degrees, standard engines don't produce as much torque as they would if the piston were offset directly above the crank journal when it was at 90 degrees of rotation, pushing directly down. Accordingly, conventional engines waste most of the energy from combustion. Conventional engines deliver almost zero torque as combustion pressure peaks. Conventional engines not only never generate full torque, they never even produce “good” torque. Conventional engines convert a mere fraction of combustion force to torque. The present crank assembly remedies these deficiencies of the conventional engine.

It is an object of the present crank assembly to increase the fuel mileage of internal combustion engines. Moreover, all embodiments of the present crank assembly would increase the fuel efficiency of hybrid vehicles through a major improvement in the efficiency of the gasoline-powered engines used for auxiliary power, and to recharge a hybrid's batteries.

It is an object of the present crank assembly to overcome the limitations of the prior art.

Other features and advantages inherent in the crank assemblies claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the crank assembly.

FIG. 2 is an illustration of a plan view of one embodiment of the crank assembly at the start of combustion stroke (the piston is about to be moved by explosive combustion).

FIG. 3 is an illustration of a plan view of one embodiment of the crank assembly at about the middle of combustion stroke.

FIG. 4 is an illustration of a plan view of one embodiment of the crank assembly at the end of combustion stroke.

FIG. 5 is an illustration of a plan view of a portion of one embodiment of the crank assembly and shows the follower gear.

FIG. 6A is an illustration of a side view of one embodiment of the connecting rod of one embodiment of the crank assembly.

FIG. 6B is an illustration of a perspective view of one embodiment of the connecting rod of one embodiment of the crank assembly.

FIG. 7 is an illustration of a plan view of another embodiment of the crank assembly.

FIG. 8 is a perspective view of another embodiment of the crank assembly.

FIG. 9 is a perspective and exploded view of another embodiment of the crank assembly.

FIG. 10 is a perspective view of another embodiment of a crank assembly and shows two assemblies driving the same crank shaft.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shots, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term oblong generally refers to a pill capsule, oval, or elliptical shape that may have two substantially flat sides or be entirely curved or rounded.

For instance, the term “gear” generally refers to a spur gear, internal ring gear, or helical gear device. The term “gears” may also refer to gear teeth, which may be on a ring, disc, elliptical, and/or oblong gear or geared device.

In the present crank assembly, the conventional connecting rod is replaced by a connecting rod that may be longer than conventional connecting rods.

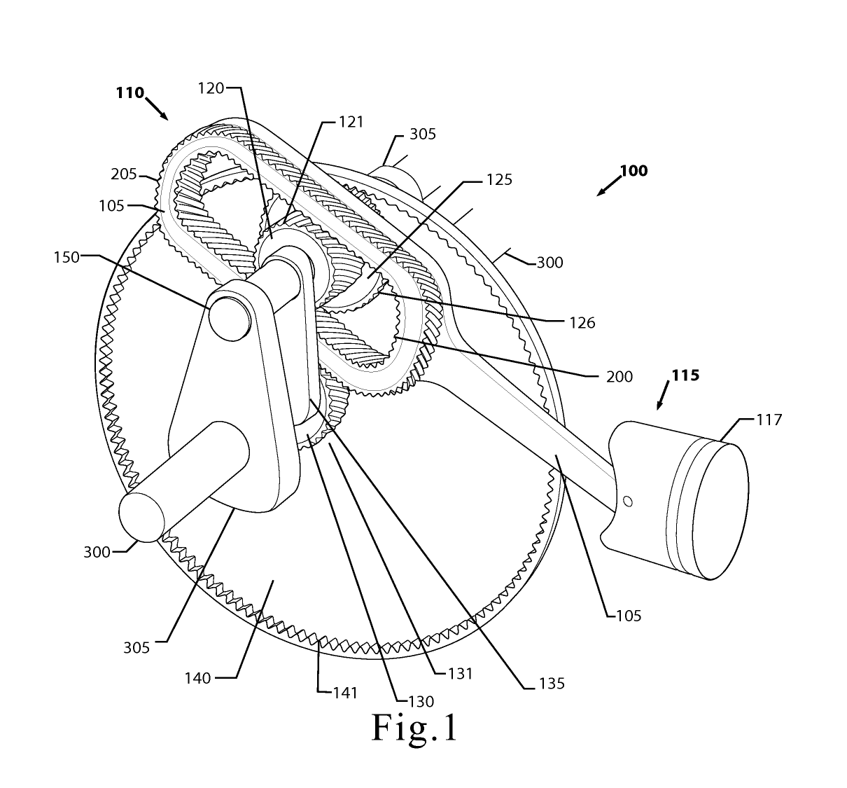

FIG. 1 is an illustration of a perspective view of one embodiment of the crank assembly. As shown in FIG. 1, the crank assembly 100 may comprise: a connecting rod 105, a first gear 120, a second gear 125, a follower gear 130, a follower gear connector 135, a geared rotational guide 140, and a crank journal 150. FIG. 1 shows that the connecting rod 105 may have a piston end 115 and a gear end 110. The piston end 115 may be connected to a piston 117, such that the piston 117 drives connecting rod 105. Preferably, the gear end 110 may be substantially oblong in shape. As shown in FIG. 1, the oblong shaped gear end 110 may have rounded short ends and flat long sides. However, the gear end 110 may be elliptical, curved, or oval shaped.

As shown in FIG. 1, the oblong gear end 110 of the connecting rod 105 may be hollow or ring shaped and may have a geared interior surface 200 and a geared exterior surface 205. As shown, the geared interior surface 200 may matingly engage with the gear teeth 121 of the first gear 120. The geared interior surface 200 of the oblong gear end 110 of the connecting rod 105 may have a long side length and a short side length. As shown, the short side length may be greater than the diameter of the first gear 120. The geared exterior surface 205 of the oblong gear end 110 of the connecting rod 105 may matingly engage with the gear teeth 131 of the follower gear 130.

FIG. 1 also shows that the crank journal 150 may be positioned within the first gear 120. Preferably, the first gear 120 may be freely rotatable around the crank journal 150. In this embodiment, the connecting rod 105 may preferably drive first gear 120 from the bottom of the combustion stroke in order to have the crank journal 150 and the driveshaft 300 turn clockwise. In the event that it is desired to have the crank journal 150 and the driveshaft 300 turn counterclockwise, the connecting rod 105 may preferably drive first gear 120 from the top of the combustion stroke. In either of these two modes, the first gear 120 and second gear 125 generally turn in the opposite direction of the crank journal 150 and driveshaft 300. Preferably, there is as little friction between the opposite turning parts as possible.

Preferably the crank journal 150 is in a fixed relationship with the cams 305. As shown in FIG. 1, the follower gear 130 and the crank journal 150 may be connected via a follower gear connector 135. The follower gear connector 135 preferably holds and secures the follower gear 130 and the first gear 120 on opposite sides of the oblong gear end 110 of the connecting rod 105. This may allow the first gear 120 to be in moveable but continuous contact with the geared interior surface 200 of the oblong gear end 110 of the connecting rod 105 while the follower gear 130 may be in moveable but continuous contact with the geared exterior surface 205 of the oblong gear end 110 of the connecting rod 105. In this embodiment, the first gear 120 and the follower gear 130, snuggly hold each other in place on opposite sides of the oblong gear end 110, such that, as the first gear may be driven to rotate within the interior 200 of the oblong gear end 110, the follower gear 130 may be forced to rotate in an opposite direction on the outside 205 of the oblong gear end 110. Although rotating in opposite directions, the first gear 120 and the follower gear 130 travel in the same direction around the oblong gear end 110 as they are driven by the linear motion of the piston 117. The follower gear connector 135 preferably holds the first gear 120 and the follower gear 130 loosely but snugly to opposite sides of the oblong gear end 110. The follower gear connector 135 may be rigid, elastic, spring loaded, telescoping, static length, adjustable length, and/or flexible in order to accomplish the task of holding the first gear 120 and the follower gear 130 to the oblong gear end 110.

In one embodiment, the follower gear 130 and follower gear connector 135 may keep the connecting rod 105 meshed with the first gear 120 because the follower gear connector 135 generally has a fixed length, which forces any section of the connecting rod's 105 oblong gear end 110 to remain at a perfect 90-degree orientation to the contact point of the first gear 120, which may be preferably substantially circular. In this manner, the connecting rod 105 may be held tightly and/or fittingly against the first gear 120 at all times. As the connecting rod 105 reaches either end of its travel, the freely-turning follower gear 130 and the follower gear connector 135 are generally forced to rotate around the short ends of the connecting rod 105. Preferably, the follower gear connector 135 and its fixed length force the follower gear 130 to remain directly above the contact point of the first gear 120 that may be just inside the connecting rod 105. As the first gear 120 and the follower gear 130 go around the short end curves of the connecting rod 105, they maintain in contact with the connecting rod 105 as the connecting rod 105 reverses direction.

As shown in FIG. 1, the first gear 120 may be connected to the second gear 125. In this embodiment, when the first gear 120 may be rotated, the second gear 125 may be rotated in the same direction as the first gear 120. As shown, the second gear 125 may matingly engage with and rotationally move within the geared interior surface 141 of the geared rotational guide 140. Preferably, the geared rotational guide 140 may be static or unmovable, such that the geared rotational guide 140 allows the second gear 125 to travel in a set rotational path that may be substantially circular. Preferably, the geared rotational guide 140 may be substantially circular. The motion of the second gear 125 along the geared interior surface 141 of the geared rotational guide 140 may indirectly or directly cause or allow the crank journal 150 to move in a substantially circular path or motion.

The piston 117 may be hingedly connected to the connecting rod 105, such that, when the piston 117 moves linearly as a result of combustion, the connecting rod 105 may move in a substantially linear manner, but may also tilt with respect to the piston 117. This allows the connecting rod 105 to hinge back and forth during operation. FIG. 1 shows that the piston 117 linearly drives the connecting rod 105. The first gear 120, which may be held matingly and snuggly to the interior 200 of the oblong end 110 of the connecting rod 105, may be driven by the motion of the connecting rod 105. As the first gear 120 may be driven and rotated, the second gear 125 may also be rotated. When the second gear 125 may be rotated, it may be forced to move in a substantially circular path within the geared rotational guide 140. Because the crank journal 150 may be rotateably received by the first gear 120, which rotates within the second gear 125, the crank journal 150 may move in a substantially circular path.

As shown in FIG. 1, the crank journal 150 may be connected directly or indirectly to a driveshaft 300, such that the driveshaft 300 rotates when the crank journal 150 moves in a substantially circular motion. FIG. 1 shows how the driveshaft 300 may be preferably connected to the crank journal 150 through cams 305.

Preferably, there may be a plurality of crank assemblies 100 that are connected to and work together to rotate the driveshaft 300.

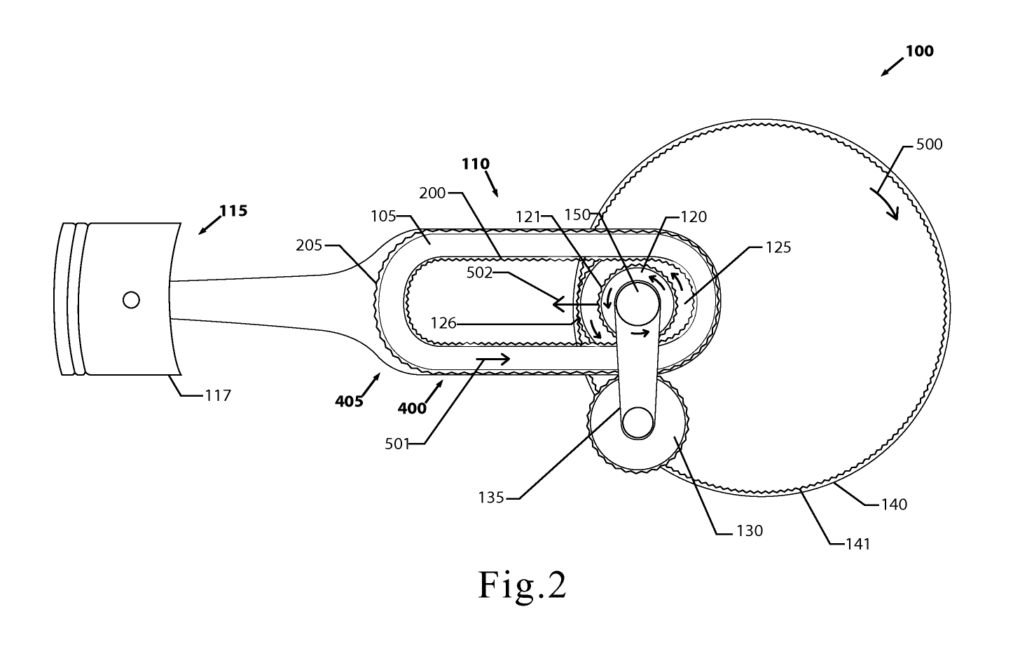

FIG. 2 is an illustration of a plan view of one embodiment of the crank assembly at the start of combustion stroke (the piston is about to be moved by explosive combustion). As shown in FIG. 2, the crank assembly 100 may comprise: a connecting rod 105, a first gear 120, a second gear 125, a follower gear 130, a follower gear connector 135, a geared rotational guide 140, and a crank journal 150. FIG. 2 shows that the connecting rod 105 may have a piston end 115 and a gear end 110. The piston end 115 may be connected to a piston 117, such that the piston 117 drives connecting rod 105. Preferably, the gear end 110 may be substantially oblong in shape. As shown, the oblong (or pill capsule) shaped gear end 110 may have rounded short ends and flat long ends. However, the gear end 110 may be elliptical or oval shaped.

As shown in FIG. 2, the oblong gear end 110 of the connecting rod 105 may comprise a gear ring 400 and gear ring support 405. The gear ring 400 may have a geared interior surface 200 and a geared exterior surface 205. As shown, the geared interior surface 200 may matingly engage with the gear teeth 121 of first gear 120. The geared interior surface 200 of the oblong gear end 110 of the connecting rod 105 may have a long side length and a short side length. As shown, the short side length may be greater than the diameter of the first gear 120. The geared exterior surface 205 of the oblong gear end 110 of the connecting rod 105 may matingly engage with the gear teeth 131 of follower gear 130.

FIG. 2 also shows that the crank journal 150 may be rotateably received by the first gear 120. Preferably, the first gear 120 may be freely rotatable around the crank journal 150. Preferably, the second gear 125 is in a fixed relationship with the first gear 120. Indeed, the first gear 120 and second gear 125 may even be constructed from the same piece of metal. Accordingly, crank journal 150 is preferably freely rotatable with respect to the second gear 125. The crank journal is preferably in a fixed relationship with the cams 305 (as shown in FIG. 1). As shown in FIG. 2, the follower gear 130 and the crank journal 150 may be connected via a follower gear connector 135. The follower gear connector 135 preferably holds the follower gear 130 and the first gear 120 on opposite sides of the oblong gear end 110 of the connecting rod 105, such that the first gear 120 may be in moveable but continuous contact with the geared interior surface 200 of the oblong gear end 110 of the connecting rod 105 while the follower gear 130 may be in moveable but continuous contact with the geared exterior surface 205 of the oblong gear end 110 of the connecting rod 105. In this embodiment, the first gear 120 and the follower gear 130 may snugly hold each other in place on opposite sides of the oblong gear end 110, such that, as the first gear may be driven to rotate within the interior 200 of the oblong gear end 110, the follower gear 130 may be forced to rotate in an opposite direction on the outside 205 of the oblong gear end 110. Although rotating in opposite directions, the first gear 120 and the follower gear 130 may travel in the same direction around the oblong gear end 110 as they are driven by the linear motion of the piston 117. The follower gear connector 135 preferably holds the first gear 120 and the follower gear 130 loosely but snugly to opposite sides of the oblong gear end 110. The follower gear connector 135 may be rigid, elastic, spring loaded, telescoping, and/or flexible in order to accomplish the task of holding the first gear 120 and follower gear 130 to the oblong gear end 110.

As shown in FIG. 2, the first gear 120 may be connected to the second gear 125. In this embodiment, when the first gear 120 is rotated, the second gear 125 may be rotated in the same direction as the first gear 120. As shown, the second gear 125 may matingly engage with and rotationally move within the geared interior surface 141 of the geared rotational guide 140. Preferably, the geared rotational guide 140 may be static or unmovable, such that the geared rotational guide 140 may allow the second gear 125 to travel in a set rotational path, which may be substantially circular. Preferably, the geared rotational guide 140 may be substantially circular. The motion 500 of the second gear 125 along the geared interior surface 141 of the geared rotational guide 140 may indirectly or directly cause or allow the crank journal 150 to move in a substantially circular path or motion.

The piston 117 may be hingedly connected to the connecting rod 105, such that when the piston moves linearly as a result of combustion, the connecting rod 105 moves in a substantially linear manner, but may also tilt with respect to the piston. This preferably allows the connecting rod 105 to hinge back and forth during operation. FIG. 2 shows that the piston 117 linearly drives 501 the connecting rod 105. The first gear 120, which may be held matingly and snugly to the interior 200 of the oblong end 110 of the connecting rod 105, may be driven 502 by the motion of the connecting rod 105. As the first gear 120 is driven and rotated, the second gear 125 may be also rotated. When the second gear 125 is rotated, the second gear 125 may be forced to move in a motion 500 that may be a substantially circular path within the geared rotational guide 140. Because the crank journal may be rotateably received by the first gear 120, which rotates the second gear 125, the crank journal 150 may moves in a substantially circular path.

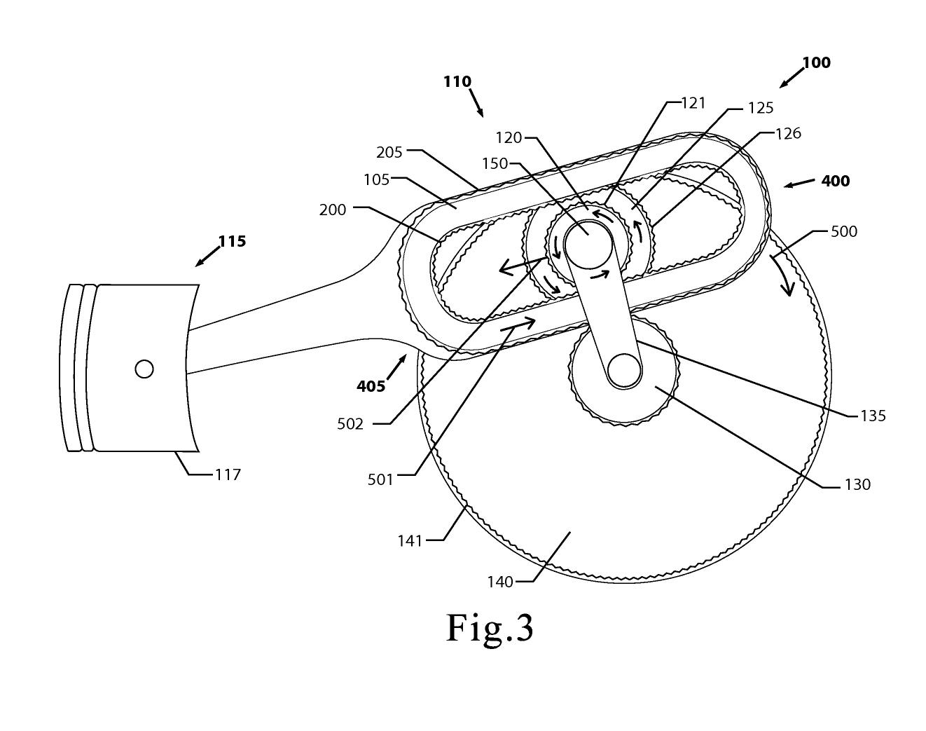

FIG. 3 is an illustration of a plan view of one embodiment of the crank assembly at about the middle of combustion stroke. As shown in FIG. 3, second gear 125 preferably continues to have motion 500 within geared rotational guide 140. The connecting rod 105 preferably continues to be driven 501 by the piston 117. First gear 120 may be driven 502 along connecting rod 105.

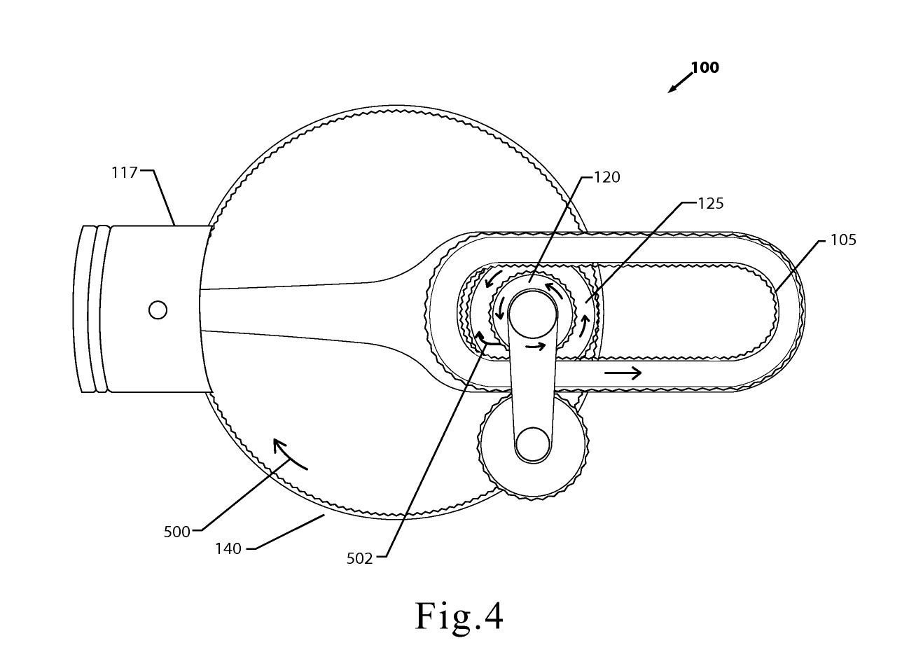

FIG. 4 is an illustration of a plan view of one embodiment of the crank assembly at the end of combustion stroke. As shown in FIG. 4, second gear 125 preferably has moved 500 to the far side of geared rotational guide 140. The connecting rod 105 preferably continues to be driven 501 by the piston 117. First gear 120 has been driven 502 to the near end of connecting rod 105.

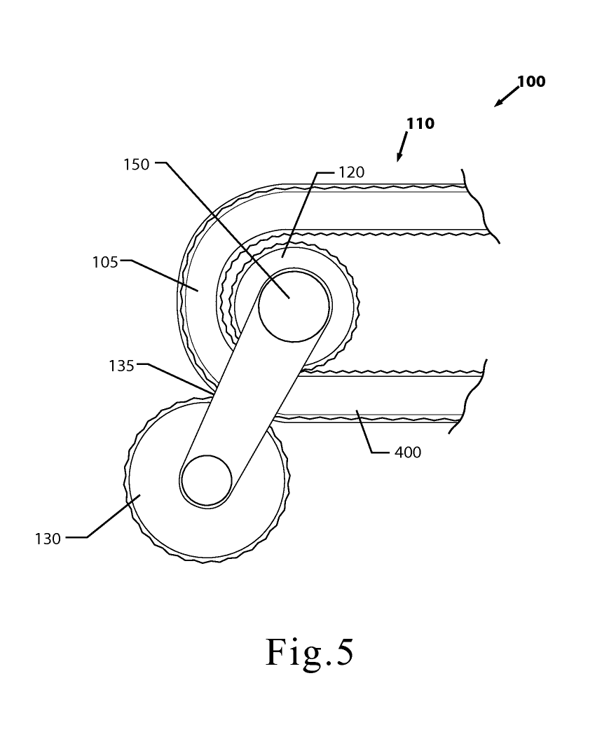

FIG. 5 is an illustration of a plan view of a portion of one embodiment of the crank assembly and shows the follower gear. As shown in FIG. 5, the crank assembly 100 may comprise: a connecting rod 105, which generally has an oblong gear end 110, a first gear 120, a crank journal 150, a follower gear 130, and a follower gear connector 135. FIG. 5 shows how the follower gear connector 135 connects to the follower gear 130, such that the first gear 120 and the follower gear 130 are secured on opposite sides of the oblong gear end 110.

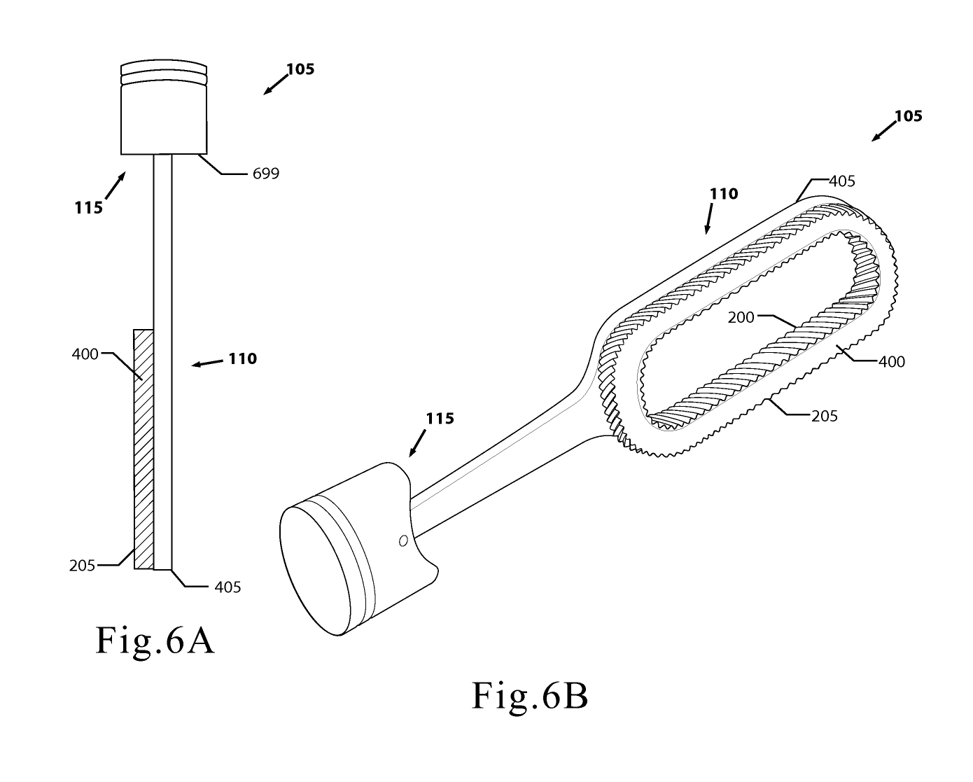

FIG. 6A is an illustration of a side view of one embodiment of the connecting rod of one embodiment of the crank assembly. As shown in FIG. 6A the connecting rod 105 has a piston end 115, an oblong geared end 110. The oblong geared end 110 may have a gear ring 400 and a gear ring support 405. The gear ring 400 may have a geared interior surface 200 and a geared exterior surface 205, which, as shown, may preferably comprise helical gears. However, the gears may be spur gears or have other types of gear teeth. FIG. 6A also shows how the connecting rod 105 may be connected to piston 699.

FIG. 6B is an illustration of a perspective view of one embodiment of the connecting rod of one embodiment of the crank assembly. As shown in FIG. 6B, the connecting rod 105 may have a piston end 115 and an oblong geared end 110. The oblong geared end 110 may have a gear ring 400 and a gear ring support 405. The gear ring 400 may have geared interior surface 200 and a geared exterior surface 205, which, as shown, may preferably comprise helical gears. However, the gears may be spur gears or have other types of gear teeth.

One feature of conventional connecting rod/crank designs is that the piston, and thus the connecting rod, does not travel at a constant speed throughout its stroke. The piston slows down at either ends of its travel, before reversing direction. This is generally because the direction of the crank journal's motion is usually only aligned with the linear motion of the piston when the piston is in the middle of its stroke. From there, the two planes of motion gradually diverge from each other until the crank journal is moving at about a 90 degree orientation to the piston's plane of travel, as the piston comes to a stop. This significantly eases the inertial forces at work each time the piston must stop and reverse direction, but these inertial forces rise substantially at higher revving or revolutions per minute (rpm). This embodiment of the present crank assembly generally maintains this design feature since ultimately the present crank assembly turns a crank whose plane of motion also diverges from the plane of the piston's travel. Therefore, although the present crank assembly delivers greatly increased torque compared to the conventional design, the minimization of inertial forces is maintained, which is important to a motor that must revolve at several thousand rpm without mechanical failure.

During the combustion cycle, the force of the piston 117 may drive the gears and crank journal 150 to turn. In the other three phases of engine operation—intake, compression, exhaust—the crank journal 150 is preferably turning the first gear 120 and the second gear 125, which forces the connecting rod 105 and piston 117 through these other cycles, just as a crank journal does with the connecting rod and piston in a conventional engine design. The inefficiency of conventional engine design means that, depending on the number of cylinders, cylinders in their combustion phase are losing efficiency while another cylinder is reaching the top of its compression stroke, where compression resistance is peaking. Thus, compression resistance is climbing as combustion efficiency in the relevant combustion cylinder is falling. But, in the present crank assembly, the flatter torque curve of the combustion cylinder is generally better able to deliver power to the vehicle and the compression phase of another cylinder at the same time. This may result in a smoother delivery of power, and reduced power loss during compression.

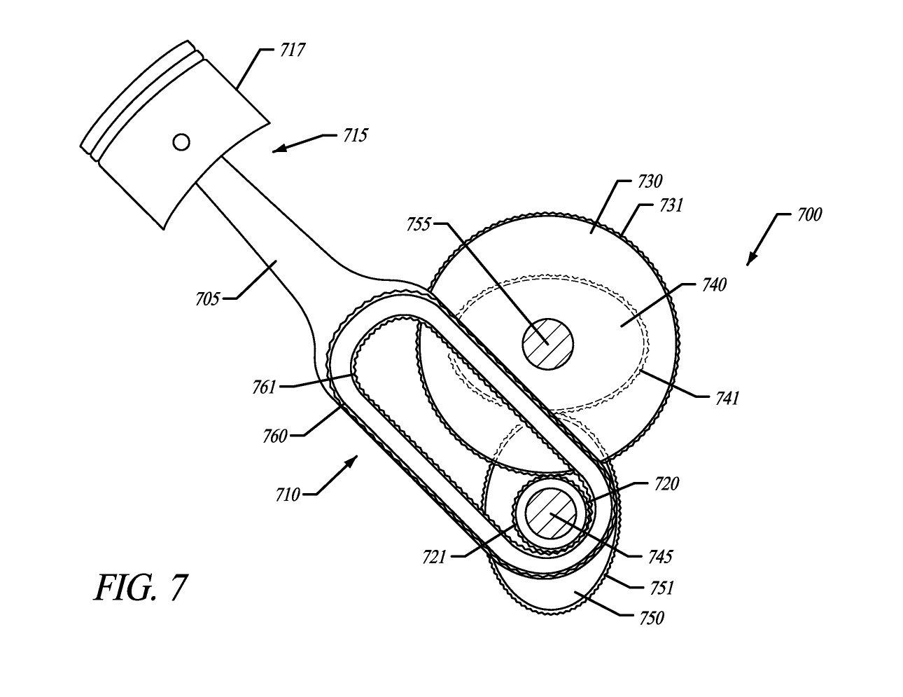

FIG. 7 is an illustration of a plan view of another embodiment of the crank assembly. As shown in FIG. 7, the crank assembly 700 may comprise a connecting rod 705, a first gear 720, a second gear 730, a third gear 740, a driveshaft 745, a countershaft 755, and a fourth gear 750. FIG. 7 shows that the connecting rod 705 may have a piston end 715 and a gear end 710. The piston end 715 may be connected to a piston 717, such that the piston 717 drives connecting rod 705. Preferably, the gear end 710 is substantially oblong in shape. As shown, the oblong shaped gear end 710 may have rounded short ends and flat long sides. However, the gear end 710 may be elliptical or oval shaped.

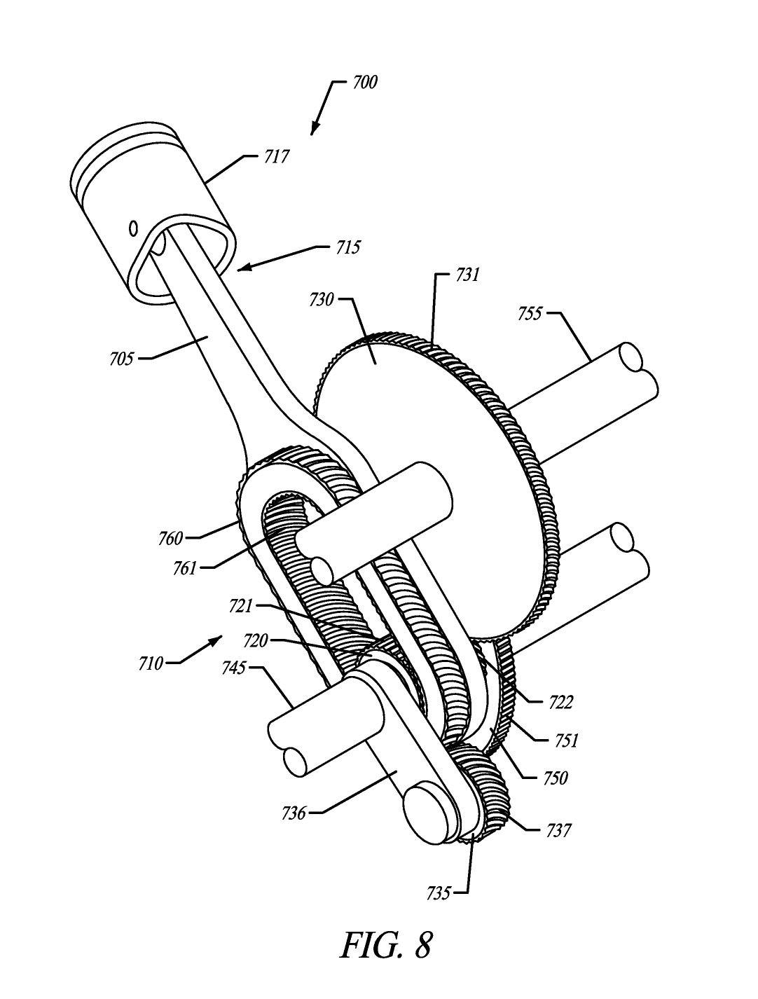

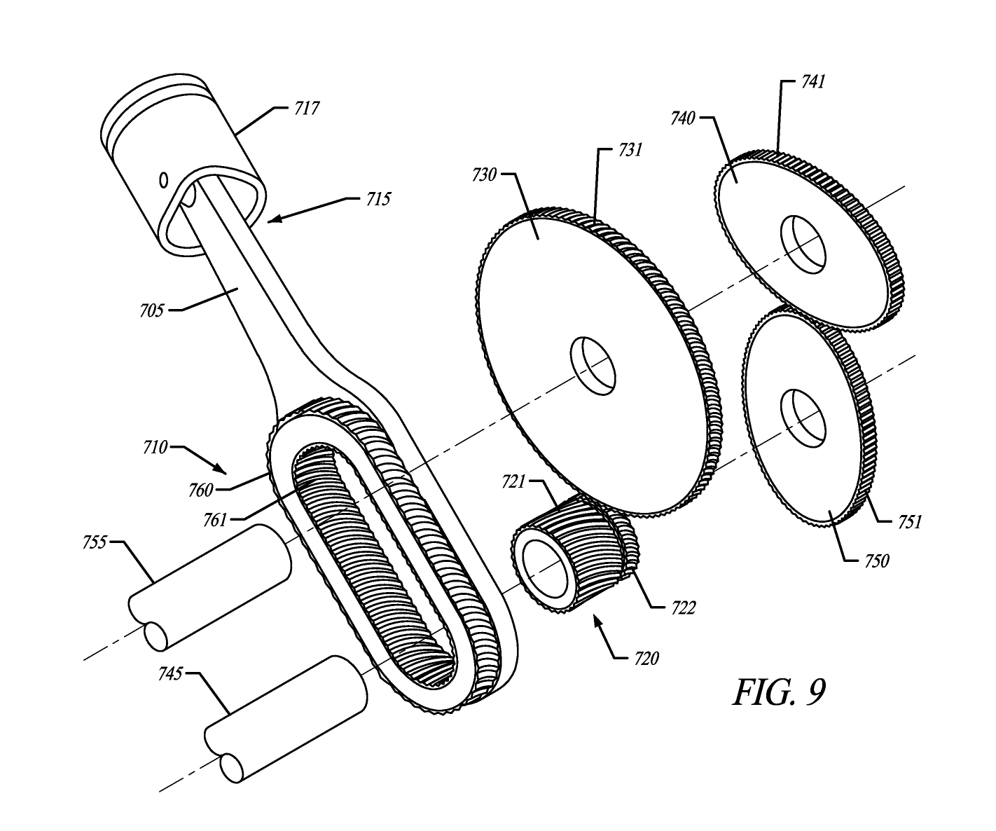

As shown in FIG. 7, the oblong gear end 710 of the connecting rod 705 may be partially hollow or ring shaped, and may have a geared interior surface 761 and a geared exterior surface 760. The first gear 720 may comprise two separate sets of gear teeth 721, 722 (shown in FIGS. 8 and 9). Also shown in FIG. 7, the geared interior surface 761 may matingly engage with the gear teeth 721 of first gear 720. The geared interior surface 761 of the oblong gear end 710 of the connecting rod 705 may have a long side length and a short side length. As shown, the short side length is generally greater than the diameter of the first gear 720. The first gear 720 may be freely rotatable around the driveshaft 745.

FIG. 8 is a perspective view of another embodiment of the crank assembly. As shown in FIG. 8, the crank assembly 700 may comprise: a connecting rod 705, a first gear 720, a second gear 730, a follower gear 735, a follower gear connector 736, a driveshaft 745, a countershaft 755, and a fourth gear 750. FIG. 7 shows that the connecting rod 705 may have a piston end 715 and a gear end 710. The piston end 715 may be connected to a piston 717, such that the piston 717 drives connecting rod 705. Also shown in FIG. 8, the geared interior surface 761 may matingly engage with the gear teeth 721 of first gear 720. The geared exterior surface 760 of the oblong gear end 710 of the connecting rod 705 may matingly engage with the gear teeth 737 of follower gear 735. As shown in FIG. 8, in one embodiment the follower gear 735 may be connected to the drive shaft 745 via a follower gear connector 736. The drive shaft 745 is preferably freely rotatable with respect to the follower gear connector 736, with friction between the two minimized as much as possible. The follower gear connector 736 preferably holds the follower gear 735 on the opposite side of the oblong gear end 710 from first gear 720 of the connecting rod 705. In this embodiment, gear teeth 721 of first gear 720 are generally in moveable but continuous contact with the geared interior surface 761 of the oblong gear end 710 of the connecting rod 705. Additionally, the gear teeth 737 of the follower gear 735 may be in moveable but continuous contact with the geared exterior surface 760 of the oblong gear end 710 of the connecting rod 705. In this embodiment, the first gear 720 and the follower gear 735, are generally snugly held on opposite sides of the oblong gear end 710, such that as the first gear 720 is forced to rotate within the interior 761 of the oblong gear end 710, and the follower gear 735 is forced to rotate in an opposite direction on the outside 760 of the oblong gear end 710. Although rotating in opposite directions, the first gear 720 and the follower gear 735 may remain in essentially a static position relative to each other on either side of the connecting rod 705 as the oblong gear end 710 moves between them as the oblong gear end 710 is driven by the linear motion of the piston 717. The follower gear connector 736 preferably holds the first gear 720 and the follower gear 735 loosely but snugly to opposite sides of the oblong gear end 710. The follower gear connector 736 may be rigid, elastic, spring loaded, telescoping, and/or flexible in order to accomplish the task of holding the gears 720, 735 to the oblong gear end 710.

As shown in FIG. 8, the teeth 722 of the first gear 720 may engage the teeth 731 of the second gear 730. In this embodiment, when the first gear 720 is rotated, the second gear 730 may be rotated in the opposite direction as the first gear 720. As shown, the second gear 730 may preferably be substantially round in shape and may have a diameter that is larger than the diameter of first gear 720. Preferably, the second gear 730 may between two to ten times larger, preferably approximately four times larger, than the first gear 720. The gear teeth 731 may matingly engage with gear teeth 722 of first gear 720.

As shown, the third gear 740 may be substantially elliptical in shape. Preferably, the third gear 740 is solidly mated to second gear 730 and is forced to rotate with second gear 730. FIG. 7 shows that the elliptical or oval second third and fourth gears 740 and 750 are set such that the short end of one gear engages with the long end of the other gear. Third and fourth gears then alternate short to long as the second gear 730 drives third gear 740, which then drives gear 750. Preferably, second and third gears 730 and 740 are freely rotatable around countershaft 755 with friction minimized as much as possible.

As with all engines, the rotation of the driveshaft is generally at a “constant speed” relative to the rotation of the wheels of the vehicle. But the two oval gears 740, 750 in this embodiment allow the piston 717 to slow down at either end of the linear path of travel of the piston 717, reducing inertial forces before the piston 717 must stop and reverse direction. The piston 717 and connecting rod 705 traveling at maximum speeds which must come to a complete stop, may then reverse direction, resulting in elevated inertial forces, which would not only reduce efficiency but reduce the revolutions-per-minute the engine is capable of achieving without catastrophic failure. Thus, it is preferred that third and fourth gears 740, 750 be oval to compensate for these elevated inertial forces. Although this embodiment may deliver optimum power with a longer-stroke geometry at lower revving (lower revolutions per minute (rpm), the ability of an engine burning high-octane fuel to reach thousands of revolutions per minute is still important to acceleration and the development of peak horsepower. The two oval gears 740, 750 may maintain the reduction in piston speed at either end of the stroke seen in current engine design with standard connecting rod and crank, which is essential to high-revving engines.

FIG. 7 shows that the teeth 741 of third gear 740 engages the teeth 751 of fourth gear 750, which preferably may be a substantially elliptical or oval gear. Preferably, when the third gear 740 is rotated the fourth gear 750 is also rotated. The fourth gear 750 is preferably the drive gear and is connected to the drive shaft 745, such that when the fourth gear 750 is rotated the drive shaft 745 is also rotated.

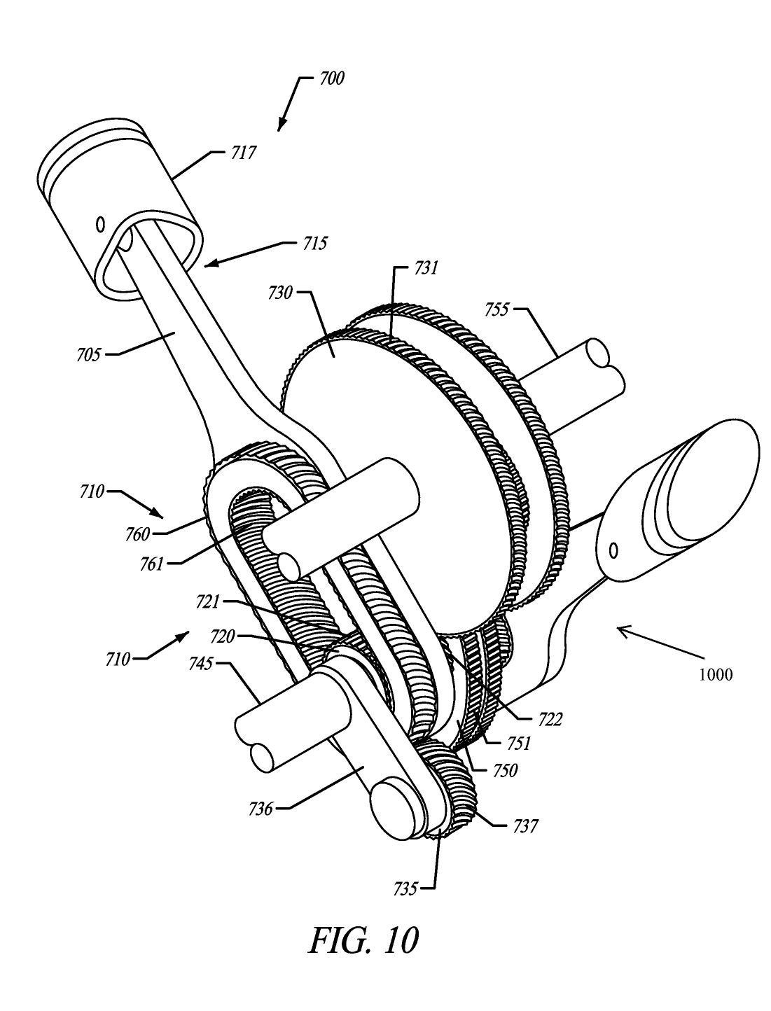

In the embodiment shown in FIGS. 7-9, the piston 717 linearly drives the connecting rod 705, which may slide between first gear 720 and follower gear 735 and cause first gear 720 to rotate, which in turn may cause the second gear 730 to rotate, which causes the third gear 740 to rotate, which causes the fourth gear 750 to rotate, which causes the fourth gear 750 and driveshaft 745 to rotate. Typically, there will be a plurality of crank assemblies 700 that are connected to and work together to rotate the driveshaft 745 as shown in FIG. 10. The piston 717 may be hingedly connected to the connecting rod 705, such that when the piston 717 moves linearly as a result of combustion. The connecting rod 705 moves in a substantially linear manner, but may also tilt with respect to the piston 717. This allows the connecting rod 705 to hinge back and forth during operation.

FIG. 9 is a perspective and exploded view of another embodiment of crank assembly. As shown in FIG. 9, the crank assembly 700 may comprise a connecting rod 705, a first gear 720, a second gear 730, a third gear 740, a follower gear 735 (shown in FIG. 8), a follower gear connector 736 (shown in FIG. 8), a driveshaft 745, a countershaft 755, and a fourth gear 750. FIG. 9 shows that the connecting rod 705 may have a piston end 715 and a gear end 710. The piston end 715 may be connected to a piston 717, such that the piston 717 drives connecting rod 705. As shown in FIG. 9, the oblong gear end 710 of the connecting rod 705 may be partially hollow or ring shaped, and may have a geared interior surface 761 and a geared exterior surface 760. First gear 720 may comprise two separate sets of gear teeth 721 and 722. Also shown in FIG. 9, the geared interior surface 761 may matingly engage with the gear teeth 721 of first gear 720. The geared interior surface 761 of the oblong gear end 710 of the connecting rod 705 may have a long side length and a short side length. As shown, the short side length is greater than the diameter of the first gear 720. The first gear 720 may be freely rotatable around the driveshaft 745.

FIG. 10 is a perspective view of another embodiment of a crank assembly and shows two assemblies driving the same crank shaft. FIG. 10 shows that there may be a plurality of crank assemblies 700, 1000. As shown, both crank assemblies may have a piston that linearly drives the connecting rods, which may slide between first gears and follower gears and cause the first gears to rotate, which in turn may cause the second gears to rotate, which causes the third gears to rotate, which causes the fourth gears to rotate, which cause the fourth gears and driveshaft 745 to rotate.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A crank assembly, comprising:
a connecting rod;
a first gear;
a second gear;
a geared rotational guide; and
a crank journal;
wherein said connecting rod has a gear end and wherein said gear end of said connecting rod is substantially oblong in shape;
wherein said oblong gear end of said connecting rod comprises a first geared interior surface;
wherein said first geared interior surface of said oblong gear end of said connecting rod is configured to matingly engage with said first gear;
wherein said first geared interior surface of said oblong gear end of said connecting rod has a long side length and a short side length;
wherein said short side length is greater than a diameter of said first gear;
wherein said crank journal is rotateably received by said first gear;
wherein said first gear is configured to be in moveable but continuous contact with said first geared interior surface of said oblong gear end of said connecting rod;
wherein said first gear is connected to said second gear, such that when said first gear is rotated said second gear is also rotated;
wherein said second gear is configured to matingly engage with and rotationally move within a second geared interior surface of said geared rotational guide; and
wherein said second gear's motion along said second geared interior surface of said geared rotational guide causes said crank journal to move in a substantially circular motion.

2. The crank assembly of claim 1, wherein said geared rotational guide is substantially circular; and
wherein said crank journal is connected to a crankshaft, and wherein said crankshaft is rotated when said crank journal moves in said substantially circular motion.

3. The crank assembly of claim 1, wherein said connecting rod has a piston end that is configured to be connected to and driven by a piston.

4. The crank assembly of claim 3, wherein said piston linearly drives said connecting rod, which in turn drives said first gear, which moves said second sear within said geared rotational guide.

5. The crank assembly of claim 1, further comprising:
a follower gear; and
a follower gear connector;

6. The crank assembly of claim 4, wherein said oblong gear end of said connecting rod further comprises a geared exterior surface; and
wherein said geared exterior surface of said oblong gear end of said connecting rod is configured to matingly engage with said follower gear.

7. The crank assembly of claim 5, wherein said follower gear and said crank journal are connected via said follower gear connector, such that said follower gear and said first gear are on opposite sides of said oblong gear end of said connecting rod, and such that said first gear is in moveable but continuous contact with said first geared interior surface of said oblong gear end of said connecting rod while said follower gear is in moveable but continuous contact with said geared exterior surface of said oblong gear end of said connecting rod.

8. The crank assembly of claim 1, wherein said first gear is freely rotatable around said crank journal.

9. A crank assembly, comprising:
a connecting rod;
a first gear;
a second gear;
a follower gear;
a follower gear connector;
a geared rotational guide; and
a crank journal;
wherein said connecting rod has a piston end that is configured to be connected to and driven by a piston;
wherein said connecting rod has a gear end and wherein said gear end of said connecting rod is substantially oblong in shape;
wherein said oblong gear end of said connecting rod comprises a first geared interior surface and a geared exterior surface;
wherein said first geared interior surface of said oblong gear end of said connecting rod is configured to matingly engage with said first gear;
wherein said first geared interior surface of said oblong gear end of said connecting rod has a long side length and a short side length;
wherein said short side length is greater than a diameter of said first gear;
wherein said geared exterior surface of said oblong gear end of said connecting rod is configured to matingly engage with said follower gear;
wherein said crank journal is rotateably received by said first gear, such that said first gear is freely rotatable around said crank journal;
wherein said follower gear and said crank journal are connected via said follower gear connector, such that said follower gear and said first gear are on opposite sides of said oblong gear end of said connecting rod, and such that said first gear is in moveable but continuous contact with said first geared interior surface of said oblong gear end of said connecting rod while said follower gear is in moveable but continuous contact with said geared exterior surface of said oblong gear end of said connecting rod;
wherein said first gear is connected to said second gear, such that when said first gear rotates said second gear also rotates;
wherein said second gear is configured to matingly engage with and rotationally move within a second geared interior surface of said geared rotational guide;
wherein said geared rotational guide is substantially circular;
wherein said second gear's motion along said second geared interior surface of said geared rotational guide causes said crank journal to move in a substantially circular path;
wherein said piston linearly drives said connecting rod, which in turn moves and rotates said first gear, which moves said second gear within said geared rotational guide; and
wherein said crank journal is connected to a crankshaft, and wherein said crankshaft is rotated when said crank journal moves in a substantially circular motion.

10. The crank assembly of claim 9, wherein there are a plurality of crank assemblies that are connected to and work together to rotate said crankshaft.

11. A crank assembly, comprising:
a connecting rod;
a first gear;
a second gear;
a countershaft;
a third gear; and
a fourth gear;
wherein said connecting rod has a gear end and wherein said gear end of said connecting rod is substantially oblong in shape;
wherein said oblong gear end of said connecting rod comprises a geared interior surface;
wherein said geared interior surface of said oblong gear end of said connecting rod is configured to matingly engage with said first gear;
wherein said geared interior surface of said oblong gear end of said connecting rod has a long side length and a short side length;
wherein said short side length is greater than a diameter of said first gear;
wherein said first gear is connected to said second gear, such that when said first gear is rotated said second gear is also rotated;
wherein said second gear is solidly connected to said third gear such that when said second gear rotates said third gear rotates in the same direction;
wherein said third gear is matingly connected to said fourth gear, such that when said third gear is rotated said fourth gear is rotated in an opposite direction; and
wherein said fourth gear is configured to matingly engage with said driveshaft.

12. The crank assembly of claim 11, further comprising:
a follower gear; and
a follower gear connector;
wherein said oblong gear end of said connecting rod further comprises a geared exterior surface;

13. The crank assembly of claim 12, wherein said geared exterior surface of said oblong gear end of said connecting rod is configured to matingly engage with said follower gear; and
wherein said follower gear is held against said geared exterior surface via said follower gear connector, such that said follower gear and said first gear are on opposite sides of said oblong gear end of said connecting rod, and such that said first gear is in moveable but continuous contact with said geared interior surface of said oblong gear end of said connecting rod while said follower gear is in moveable but continuous contact with said geared exterior surface of said oblong gear end of said connecting rod.

14. The crank assembly of claim 11, wherein said connecting rod has a piston end that is configured to be connected to and driven by a piston.

15. The crank assembly of claim 11, wherein a driveshaft is within said first gear, such that said first gear is freely rotatable around said driveshaft.

16. The crank assembly of claim 11, wherein said second and third gears are freely rotateably around said countershaft.

17. The crank assembly of claim 11, wherein said third and fourth gears are substantially elliptical in shape.

18. The crank assembly of claim 11, wherein a piston linearly drives said connecting rod, wherein movement of said connecting rod causes said first gear to rotate, which causes said second gear to rotate, which causes said third gear to rotate, which causes said fourth gear to rotate, which causes said driveshaft to rotate.

19. The crank assembly of claim 11, wherein there are a plurality of crank assemblies that are connected to and work together to rotate said driveshaft.
